(19) United States
(12) Patent Application Publication
(10) Pub. No.: US 2025/0214325 A1
(43) Pub. Date: Jul. 3, 2025

(54) TRANSPARENT FIREPROOF PLASTIC BOARD

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); Yueh-Shin Liu, Taipei City (TW); Ci-Syuan Liou, TAIPEI (TW)

(21) Appl. No.: 18/594,105

(22) Filed: Mar. 4, 2024

(30) Foreign Application Priority Data
Dec. 27, 2023 (TW) 112150897

(51) Int. Cl. B32B 27/08; B32B 7/02; E04B 1/94

(52) U.S. Cl. CPC B32B 27/08; B32B 7/02; E04B 1/942; B32B 2250/03; B32B 2250/24; B32B 2250/40; B32B 2255/10; B32B 2255/20; B32B 2255/26; B32B 2307/302; B32B 2307/3065; B32B 2307/412; B32B 2307/7376; B32B 2607/00

(57) ABSTRACT

A transparent fireproof plastic board is provided. The transparent fireproof plastic board includes an intermediate plastic substrate and two fireproof reinforcing layers respectively formed on two opposite surfaces of the intermediate plastic substrate. The intermediate plastic substrate has a first visible light transmittance of not less than 80%, and the intermediate plastic substrate has a flame resistance grade of V0 within a thickness ranging from 0.8 mm to 6.4 mm according to UL94 testing standard. Each of the fireproof reinforcing layers has a second visible light transmittance of not less than 80%, and each of the fireproof reinforcing layers forms a carbon protective layer after being heated at a high temperature. The transparent fireproof plastic board conforms to a flame resistance grade of second level according to CNS 14705-1 testing standard.

### CROSS-REFERENCE TO RELATED PATENT APPLICATION

This application claims the benefit of priority to Taiwan Patent Application No. 112150897, filed on Dec. 27, 2023.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a plastic board, and more particularly to a transparent fireproof plastic board.

### BACKGROUND OF THE DISCLOSURE

Most fireproof boards used in construction are non-translucent boards or have poor light transmittance, thereby reducing natural lighting and the sense of space in an indoor environment. Furthermore, although some fireproof boards with the light transmittance are currently available on the market, the fireproofing capabilities thereof still have room for improvement.

### SUMMARY OF THE DISCLOSURE

In response to the above-referenced technical inadequacy, the present disclosure provides a transparent fireproof plastic board.

In order to solve the above-mentioned problems, one of the technical aspects adopted by the present disclosure is to provide a transparent fireproof plastic board. The transparent fireproof plastic board conforms to a second-level flame resistance grade according to the CNS 14705-1 testing standard. The transparent fireproof plastic board includes an intermediate plastic substrate and two fireproof reinforcing layers respectively formed on two opposite surfaces of the intermediate plastic substrate. The intermediate plastic substrate has a first visible light transmittance of not less than 80%, and the intermediate plastic substrate has a flame resistance grade of V0 within a thickness ranging from 0.8 mm to 6.4 mm according to the UL94 testing standard. Each of the fireproof reinforcing layers has a second visible light transmittance of not less than 80%, and each of the fireproof reinforcing layers is formed into a carbon protective layer after being heated at a high temperature.

In one of the possible or preferred embodiments, the carbon protective layer has a thermal conductivity lower than that of the fireproof reinforcing layer before being heated at the high temperature, so as to delay a rate of heat transferring to the intermediate plastic substrate.

In one of the possible or preferred embodiments, the intermediate plastic substrate has the flame resistance grade of V0 within the thickness ranging from 1.2 mm to 3.2 mm according to the UL94 testing standard.

In one of the possible or preferred embodiments, a plastic material of the intermediate plastic substrate is selected from the group consisting of polyethylene terephthalate, polycarbonate, polyetherimide, polyarylate, polyethersulfone, and polysulfone.

In one of the possible or preferred embodiments, the intermediate plastic substrate has a first thickness of between 1.0 mm and 30 mm, and each of the fireproof reinforcing layers has a second thickness that is 0.0005 times to 0.25 times the first thickness.

In one of the possible or preferred embodiments, each of the fireproof reinforcing layers is a coating layer formed on the surface of the intermediate plastic substrate by coating.

In one of the possible or preferred embodiments, the carbon protective layer is formed by the coating layer, the carbon protective layer has a foam structure, and the carbon protective layer has a third thickness that is 5 times to 30 times the second thickness.

In one of the possible or preferred embodiments, the coating layer is formed by an organic coating material or an inorganic coating material. The organic coating material includes an amino resin that is selected from the group consisting of aniline, dicyandiamide, melamine, diammonium phosphate, ammonium polyphosphate, and diammonium phosphate, and the inorganic coating material includes silicate that is selected from the group consisting of sodium silicate, potassium silicate, and calcium silicate.

In one of the possible or preferred embodiments, each of the fireproof reinforcing layers is a film formed on the surface of the intermediate plastic substrate through thermal bonding, the film is a fluorine-containing polymer film that is selected from the group consisting of a polyvinyl fluoride film, a polyvinylidene difluoride film, a polyfluoroalkoxy alkane film, and a fluorinated ethylenepropylene film.

In one of the possible or preferred embodiments, each of the fireproof reinforcing layers is a laminated structure, each of the fireproof reinforcing layers includes a film directly bonded to the surface of the intermediate plastic substrate through thermal bonding, and a coating layer formed by being coated on a side surface of the film that is away from the intermediate plastic substrate. The film is a fluorine-containing polymer film, and the coating layer is formed by an organic coating or an inorganic coating. The organic coating includes an amino resin, and the inorganic coating includes silicate.

Therefore, in the transparent fireproof plastic board provided by the present disclosure, by virtue of “a transparent fireproof plastic board conforming to a flame resistance grade of second level according to the CNS 14705-1 testing standard,” “an intermediate plastic substrate having a first visible light transmittance of not less than 80%, and the intermediate plastic substrate having a flame resistance grade of V0 within a thickness ranging from 0.8 mm to 6.4 mm according to the UL94 testing standard,” and “two fireproof reinforcing layers respectively forming on two opposite surfaces of the intermediate plastic substrate, each of the fireproof reinforcing layers having a second visible light transmittance of not less than 80%, and each of the fireproof reinforcing layers being formed into a carbon protective layer after being heated at a high temperature,” the transparent fireproof plastic board can have a high transparency, a high fire resistance, a wider range of applications, and can be applied in a fireproof construction material, a partition board, or a ceiling (e.g., the partition board or the ceiling of a hot aisle/cold aisle containment system of a data center).

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a transparent fireproof plastic board having a laminated structure according to a first embodiment of the present disclosure;

FIG. 2 is a schematic view of the transparent fireproof plastic board that forms a carbon protective layer after being heated at a high temperature according to the first embodiment of the present disclosure;

FIG. 3 is a schematic view of the transparent fireproof plastic board having the laminated structure according to a second embodiment of the present disclosure;

FIG. 4 is a schematic view of the transparent fireproof plastic board that forms a carbon protective layer after being heated at the high temperature according to the second embodiment of the present disclosure;

FIG. 5 is a schematic view of the transparent fireproof plastic board with the laminated structure according to a third embodiment of the present disclosure; and

FIG. 6 is a schematic view of the transparent fireproof plastic board that forms a carbon protective layer after being heated at the high temperature according to the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

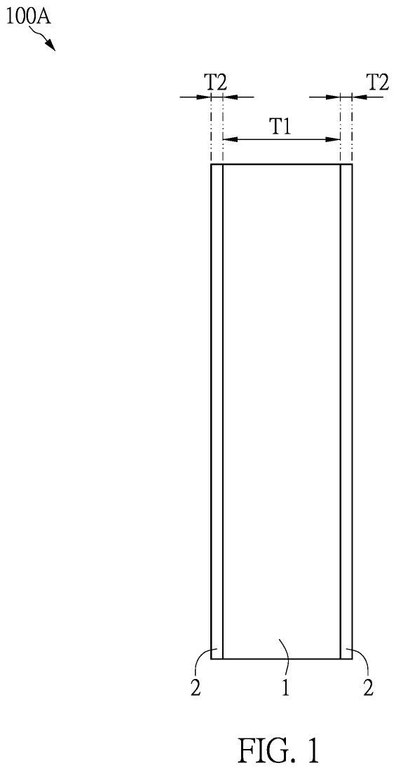

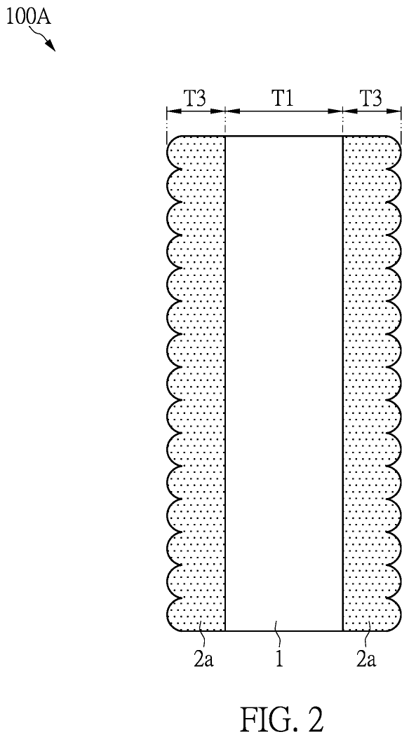

Referring to FIG. 1 and FIG. 2, a first embodiment of the present disclosure provides a transparent fireproof plastic board 100A.

FIG. 1 is a schematic view of the transparent fireproof plastic board 100A having a laminated structure before being heated at a high temperature according to the first embodiment of the present disclosure. FIG. 2 is a schematic view of the transparent fireproof plastic board 100A having the laminated structure that forms a carbon protective layer 2a after being heated at the high temperature according to the first embodiment of the present disclosure.

As shown in FIG. 1, the transparent fireproof plastic board 100A includes an intermediate plastic substrate 1 and two fireproof reinforcing layers 2, and the two fireproof reinforcing layers 2 are respectively formed on two opposite surfaces of the intermediate plastic substrate 1.

The intermediate plastic substrate 1 is a plastic substrate based on specific material properties.

More specifically, the intermediate plastic substrate 1 has a first visible light transmittance (VLT) of not less than 80%, and the intermediate plastic substrate 1 has a flame resistance grade of V0 within a thickness ranging from 0.8 mm to 6.4 mm according to the UL94 testing standard. In a preferred embodiment, the intermediate plastic substrate 1 has the flame resistance grade of V0 within the thickness ranging from 1.2 mm to 3.2 mm (and more preferably 1.6 mm) according to the UL94 testing standard.

It should be noted that the UL94 testing standard recited in the present disclosure is tested by a standard test method according to “IEC 60695-11-10 Fire hazard testing—Part 11-10: Test flames—50W horizontal and vertical flame test methods”.

The intermediate plastic substrate 1 has a first thickness T1. The first thickness T1 is between 1.0 mm and 30 mm, and the first thickness T1 is preferably between 3 mm and 20 mm.

In some embodiments of the present disclosure, a plastic material of the intermediate plastic substrate 1 is selected from the group consisting of polyethylene terephthalate (PET), polycarbonate (PC), polyetherimide (PEI), polyarylate (PAR), polyethersulfone (PES), and polysulfone (PSU).

The intermediate plastic substrate 1 further includes a flame retardant that is dispersed in the plastic material.

The flame retardant is selected from the group consisting of an inorganic flame retardant, a halogen flame retardant, a borate flame retardant, a phosphorus-containing flame retardant, a nitrogen-containing flame retardant, an intumescent flame retardant, and an organosilicone flame retardant. In a specific embodiment, the plastic material of the intermediate plastic substrate 1 is polyethylene terephthalate, and the flame retardant is phosphorus-containing flame retardant, but the present disclosure is not limited thereto.

In the present disclosure, as long as the intermediate plastic substrate 1 has the aforementioned first visible light transmittance and a flame retardancy of UL94, the intermediate plastic substrate 1 conforms to the spirit and scope of the present disclosure.

It is worth mentioning that the intermediate plastic substrate 1 is formed by an extrusion process, and an extrusion temperature of the extrusion process is between 240° C. and 400° C., but the present disclosure is not limited thereto.

As shown in FIG. 1, each of the fireproof reinforcing layers 2 is a transparent fireproof coating layer formed on the surface of the intermediate plastic substrate 1 by coating.

Each of the fireproof reinforcing layers 2 has a second visible light transmittance of not less than 80%, and each of the fireproof reinforcing layers 2 has a second thickness T2 that is 0.0005 times to 0.25 times the first thickness of the intermediate plastic substrate 1. More specifically, the second thickness T2 of each of the fireproof reinforcing layers 2 is between 10 μm and 800 μm.

More specifically, as shown in FIG. 2, each of the fireproof reinforcing layers 2 is formed into the carbon protective layer 2a after being heated at the high temperature (e.g., between 150° C. and 1500° C.) in an atmospheric environment. The carbon protective layer 2a covers the surface of the intermediate plastic substrate 1, and the carbon protective layer 2a has a thermal conductivity lower than that of the fireproof reinforcing layer 2 before being heated at the high temperature, so as to delay a rate of heat transferring to the intermediate plastic substrate 1, thereby reducing a flammability of the surface of plastic board 100A. In the present embodiment, the carbon protective layer 2a has a foam structure, and the carbon protective layer 2a has a third thickness T3. The third thickness T3 is 5 times to 30 times the second thickness T2 (e.g. the thickness of the fireproof reinforcing layers 2 before being heated at the high temperature), and the third thickness T3 is preferably 10 times to 30 times the second thickness T2.

In other words, each of the fireproof reinforcing layers 2 expands in volume after being heated at the high temperature, and is formed into the carbon protective layer 2a (e.g., a carbonaceous foam insulation layer) having the foam structure to provide a thermal insulation effect for the intermediate plastic substrate 1.

Furthermore, the carbon protective layer 2a formed after being heated at the high temperature has a third visible light transmittance that is lower than the second visible light transmittance, and the third visible light transmittance may be lower than 70%, but the present disclosure is not limited thereto. It should be noted that, the first visible light transmittance, the second visible light transmittance, and the third visible light transmittance recited in the present disclosure are tested by a standard test method according to ASTM D1003 “Standard Test Method for Haze and Luminous Transmittance of Transparent Plastics”.

As shown in FIG. 1, each of the fireproof reinforcing layers 2 is the transparent fireproof coating layer that is formed by coating an organic coating material or an inorganic coating material.

In some embodiments of the present disclosure, the organic coating material includes an amino resin that is selected from the group consisting of aniline, dicyandiamide, melamine, diammonium phosphate, ammonium polyphosphate, and diammonium phosphate.

In some embodiments of the present disclosure, the inorganic coating material includes silicate that is selected from the group consisting of sodium silicate, potassium silicate, and calcium silicate.

The aforementioned materials can react with carbon dioxide existing in the air when being heated at the high temperature, so as to form the carbon protective layer 2a having the foam structure. Furthermore, in some embodiments of the present disclosure, each of the fireproof reinforcing layers 2 further includes a carbon-forming substance added therein, such as a carbon-rich polyhydroxy compound or an organic resin with hydroxyl groups, but the present disclosure is not limited thereto.

Furthermore, the transparent fireproof plastic board 100A according to the embodiment of the present disclosure can conform to a flame resistance grade of second level according to the CNS 14705-1 testing standard through a laminated design of the intermediate plastic substrate 1 and the two fireproof reinforcing layers 2.

The CNS 14705-1 testing standard is a method of test for heat release rate for building materials.

An overall visible light transmittance of the transparent fireproof plastic board 100A can reach 80% before being heated at the high temperature according to the embodiment of the present disclosure, and can be applied on a fireproof construction material, a partition board, or a ceiling. For instance, the transparent fireproof plastic board 100A can be applied on the partition board or the ceiling of a hot aisle/cold aisle containment system of a data center (server room).

It is worth mentioning that the transparent fireproof plastic board 100A according to the embodiment of the present disclosure has a better flame resistance through the laminated design of the intermediate plastic substrate 1 and the two fireproof reinforcing layers 2.

If the two surfaces of the intermediate plastic substrate 1 are not respectively covered by the two fireproof reinforcing layers 2, the transparent fireproof plastic board may not be able to pass the CNS 14705-1 testing standard.

### Second Embodiment

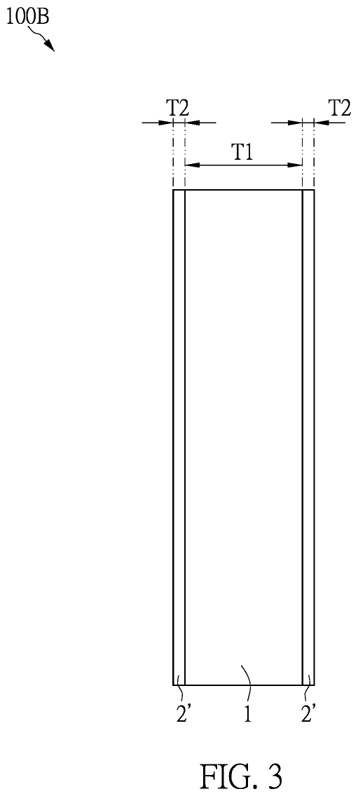

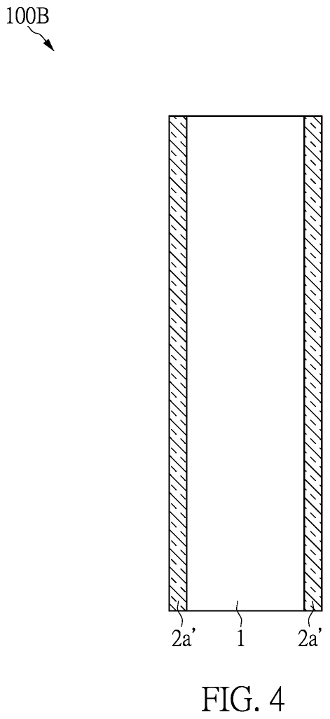

Referring to FIG. 3 and FIG. 4, a second embodiment of the present disclosure provides a transparent fireproof plastic board 100B.

FIG. 3 is a schematic view of the transparent fireproof plastic board 100B having a laminated structure before being heated at a high temperature according to the second embodiment of the present disclosure. FIG. 4 is a schematic view of the transparent fireproof plastic board 100B having the laminated structure that forms a carbon protective layer 2a′ after being heated at the high temperature according to the second embodiment of the present disclosure.

As shown in FIG. 3, the transparent fireproof plastic board 100B includes an intermediate plastic substrate 1 and two fireproof reinforcing layers 2′, and the two fireproof reinforcing layers 2′ are respectively formed on two opposite surfaces of the intermediate plastic substrate 1.

The intermediate plastic substrate 1 has a first visible light transmittance of not less than 80%.

The intermediate plastic substrate 1 has a flame resistance grade of V0 within a thickness ranging from 0.8 mm to 6.4 mm according to the UL94 testing standard.

The intermediate plastic substrate 1 has a first thickness T1, and the first thickness T1 is between 1.0 mm and 30 mm.

The remaining material properties of the intermediate plastic substrate 1 are similar to the aforementioned material properties of the first embodiment, and will not be reiterated herein.

As shown in FIG. 3, each of the fireproof reinforcing layers 2′ is a transparent flame retardant film, and each of the fireproof reinforcing layers 2′ is formed on the surface of the intermediate plastic substrate 1 through thermal bonding. The transparent flame retardant film is thermally bonded to the intermediate plastic substrate 1 with a thermal bonding temperature between 190° C. and 400° C.

Furthermore, each of the fireproof reinforcing layers 2′ has a second visible light transmittance of not less than 80%, and each of the fireproof reinforcing layers 2′ has a second thickness T2 that is 0.0005 times to 0.25 times the first thickness T1 of the intermediate plastic substrate 1. More specifically, the second thickness T2 of each of the fireproof reinforcing layers 2′ is between 10 μm and 800 μm, and more preferably between 50 μm and 500 μm.

Furthermore, as shown in FIG. 4, each of the fireproof reinforcing layers 2′ does not spontaneously ignite after being heated at the high temperature (e.g., between 350° C. and 1000° C.) in an atmospheric environment, and can be formed into the carbon protective layer 2a′. The carbon protective layer 2a′ covers the surface of the intermediate plastic substrate 1, the carbon protective layer 2a′ has a thermal conductivity lower than that of the fireproof reinforcing layers 2′ before being heated at the high temperature, so as to delay a rate of heat transferring to the intermediate plastic substrate 1, thereby reducing a flammability of the surface of transparent fireproof plastic board 100B.

In the present embodiment, after being heated at the high temperature, each of the carbon protective layers 2a′ has a slightly expanded thickness (e.g., an expansion of at least 50%) and has a high flame retardancy.

As shown in FIG. 3, the transparent flame retardant film of each of the fireproof reinforcing layers 2′ is a fluorine-containing polymer film. In some embodiments of the present disclosure, the fluorine-containing polymer film is selected from the group consisting of a polyvinyl fluoride film (PVF film), a polyvinylidene difluoride film (PVDF film), a polyfluoroalkoxy alkane film (PFA film), and a fluorinated ethylenepropylene film (FEP film).

Furthermore, the transparent fireproof plastic board 100B according to the embodiment of the present disclosure can conform to a flame resistance grade of second level according to the CNS 14705-1 testing standard through a laminated design of the intermediate plastic substrate 1 and the two fireproof reinforcing layers 2′.

### Third Embodiment

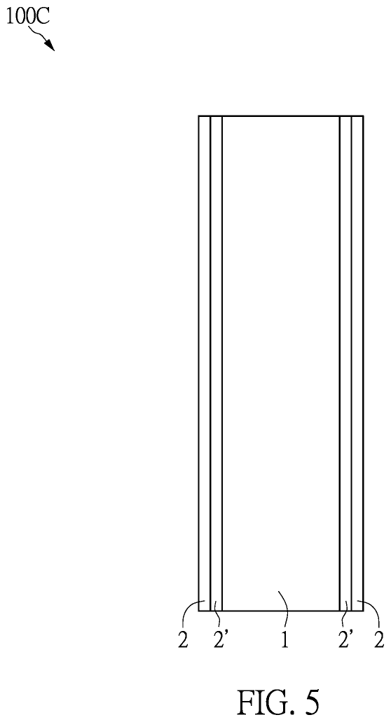

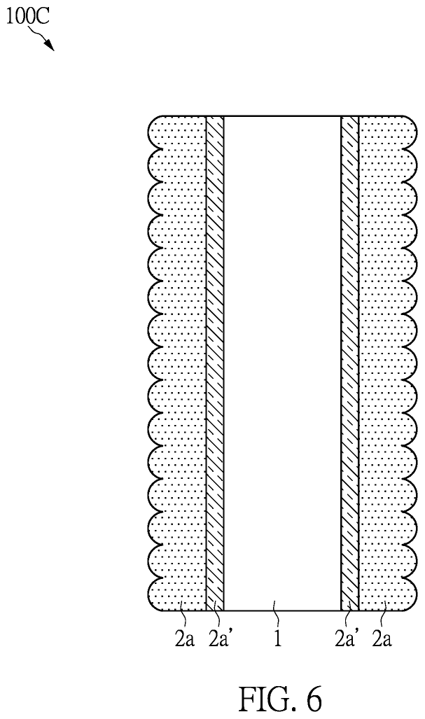

Referring to FIG. 5 and FIG. 6, a third embodiment of the present disclosure provides a transparent fireproof plastic board 100C.

FIG. 5 is a schematic view of the transparent fireproof plastic board 100C having a laminated structure before being heated at a high temperature according to the third embodiment of the present disclosure. FIG. 6 is a schematic view of the transparent fireproof plastic board 100C having the laminated structure that forms a carbon protective layer after being heated at the high temperature according to the third embodiment of the present disclosure. As shown in FIG. 5, the transparent fireproof plastic board 100C includes an intermediate plastic substrate 1 and two fireproof reinforcing layers, and the two fireproof reinforcing layers are respectively formed on two opposite surfaces of the intermediate plastic substrate 1.

A difference between the present embodiment and the aforementioned embodiments is that each of the fireproof reinforcing layers is a laminated structure that includes a first fireproof reinforcing layer 2′ and a second fireproof reinforcing layer 2.

The first fireproof reinforcing layer 2′ is a transparent flame retardant film (e.g. a polyvinyl fluoride film) as described in the aforementioned second embodiment, and the first fireproof reinforcing layer 2′ is formed on the surface of the intermediate plastic substrate 1 through thermal bonding.

Furthermore, each of the second fireproof reinforcing layers 2 is a transparent fireproof coating layer as described in the aforementioned first embodiment. Each of the fireproof reinforcing layers 2 is formed on a side surface of the first fireproof reinforcing layer 2′ that is away from the intermediate plastic substrate 1 by coating.

More specifically, as shown in FIG. 6, each of the fireproof reinforcing layers (e.g., includes 2 and 2′) forms the carbon protective layer 2a and the carbon protective layer 2a′ after being heated at a high temperature in an atmospheric environment. The carbon protective layer 2a and the carbon protective layer 2a′ cover the surface of the intermediate plastic substrate 1, so as to delay a rate of heat transferring to the intermediate plastic substrate 1, thereby reducing a flammability of the surface of the transparent fireproof plastic board 100C.

More specifically, the transparent fireproof plastic board 100C according to the embodiment of the present disclosure can conform to a flame resistance grade of second level according to the CNS 14705-1 testing standard through the laminated structure of the intermediate plastic substrate 1, the fireproof reinforcing layer 2, and the fireproof reinforcing layer 2′.

### Beneficial Effects of the Embodiments

In conclusion, the transparent fireproof plastic board provided by the present disclosure, by virtue of “a transparent fireproof plastic board conforming to a flame resistance grade of second level according to the CNS 14705-1 testing standard,” “an intermediate plastic substrate having a first visible light transmittance of not less than 80%, and the intermediate plastic substrate having a flame resistance grade of V0 within a thickness ranging from 0.8 mm to 6.4 mm according to the UL94 testing standard,” and “two fireproof reinforcing layers respectively forming on two opposite surfaces of the intermediate plastic substrate, each of the fireproof reinforcing layers having a second visible light transmittance of not less than 80%, and each of the fireproof reinforcing layers being formed into a carbon protective layer after being heated at a high temperature,” the transparent fireproof plastic board can have a high transparency, a high fire resistance, a wider range of applications, and can be applied on a fireproof construction material, a partition board, or a ceiling (e.g., the partition board or the ceiling of a hot aisle/cold aisle containment system of a data center).

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A transparent fireproof plastic board, conforming to a second-level flame resistance grade according to CNS 14705-1 testing standard, and the transparent fireproof plastic board comprising:
an intermediate plastic substrate, wherein the intermediate plastic substrate has a first visible light transmittance of not less than 80%, and the intermediate plastic substrate has a flame resistance grade of V0 within a thickness ranging from 0.8 mm to 6.4 mm according to UL94 testing standard; and
two fireproof reinforcing layers respectively formed on two opposite surfaces of the intermediate plastic substrate, wherein each of the fireproof reinforcing layers has a second visible light transmittance of not less than 80%, and each of the fireproof reinforcing layers is formed into a carbon protective layer after being heated at a high temperature.

2. The transparent fireproof plastic board according to claim 1, wherein the carbon protective layer has a thermal conductivity lower than that of the fireproof reinforcing layer before being heated at the high temperature, so as to delay a rate of heat transferring to the intermediate plastic substrate.

3. The transparent fireproof plastic board according to claim 1, wherein the intermediate plastic substrate has the flame resistance grade of V0 within the thickness ranging from 1.2 mm to 3.2 mm according to the UL94 testing standard.

4. The transparent fireproof plastic board according to claim 1, wherein a plastic material of the intermediate plastic substrate is selected from the group consisting of polyethylene terephthalate, polycarbonate, polyetherimide, polyarylate, polyethersulfone, and polysulfone.

5. The transparent fireproof plastic board according to claim 1, wherein the intermediate plastic substrate has a first thickness of between 1.0 mm and 30 mm, and each of the fireproof reinforcing layers has a second thickness that is 0.0005 times to 0.25 times the first thickness.

6. The transparent fireproof plastic board according to claim 5, wherein each of the fireproof reinforcing layers is a coating layer formed on the surface of the intermediate plastic substrate by coating.

7. The transparent fireproof plastic board according to claim 6, wherein the carbon protective layer is formed by the coating layer, the carbon protective layer has a foam structure, and the carbon protective layer has a third thickness that is 5 times to 30 times the second thickness.

8. The transparent fireproof plastic board according to claim 6, wherein the coating layer is formed by an organic coating material or an inorganic coating material, wherein the organic coating material includes an amino resin that is selected from the group consisting of aniline, dicyandiamide, melamine, diammonium phosphate, ammonium polyphosphate, and diammonium phosphate, and wherein the inorganic coating material includes silicate that is selected from the group consisting of sodium silicate, potassium silicate, and calcium silicate.

9. The transparent fireproof plastic board according to claim 1, wherein each of the fireproof reinforcing layers is a film formed on the surface of the intermediate plastic substrate through thermal bonding, wherein the film is a fluorine-containing polymer film that is selected from the group consisting of a polyvinyl fluoride film, a polyvinylidene difluoride film, a polyfluoroalkoxy alkane film, and a fluorinated ethylenepropylene film.

10. The transparent fireproof plastic board according to claim 1, wherein each of the fireproof reinforcing layers is a laminated structure, each of the fireproof reinforcing layers includes a film directly bonded to the surface of the intermediate plastic substrate through thermal bonding, and a coating layer formed by being coated on a side surface of the film that is away from the intermediate plastic substrate, wherein the film is a fluorine-containing polymer film, and the coating layer is formed by an organic coating or an inorganic coating, and wherein the organic coating includes an amino resin, and the inorganic coating includes silicate.
